(19) United States
(12) Patent Application Publication
(10) Pub. No.: US 2025/0258742 A1
(43) Pub. Date: Aug. 14, 2025

(54) SYSTEM AND METHOD FOR HANDLING TEMPORAL DELAYS IN DATA PROCESSING PIPELINES POST DEVICE RECONNECTION

(71) Applicant: Honeywell International Inc., Charlotte, NC (US)

(72) Inventor: Bhabesh Acharya, Bangalore (IN)

(21) Appl. No.: 18/752,799

(22) Filed: Jun. 25, 2024

(30) Foreign Application Priority Data
Feb. 9, 2024 (IN) 202411008815

(51) Int. Cl. G06F 11/14; G06F 11/30

(52) U.S. Cl. CPC G06F 11/1471; G06F 11/3055; G06F 11/3065

(57) ABSTRACT

A system for handling temporal delays in data processing, which has one or more devices configured to transmit data, the data comprising at least one of device status, downtime data, uptime data, metadata of the downtime data, a heartbeat listener operatively connected to the one or more devices and configured to receive the device status, a data loader operatively connected to the one or more devices and configured to persist the uptime data, a fact modeler configured to process the uptime data persisted by the data loader. The heartbeat listener determines from the device status, the downtime duration of one or more devices, transmits the metadata of the downtime data associated with the downtime duration of the one or more devices to the data loader, such that the data loader is further configured to receive and persist the downtime data from one or more devices and triggers the fact modeler to re-process the uptime and downtime data persisted by the data loader.

### TECHNICAL FIELD

Embodiments of the present disclosure generally relate to handling temporal delays in data processing pipelines and correcting calculations post device reconnection, and specifically to a system and method for efficient handling of temporal delays in persisting of data by a data loader and processing by a fact modeler in data processing pipelines, post device reconnection.

### BACKGROUND

Devices going down (or becoming offline) is a common scenario in data processing pipelines. After experiencing downtime, when a device comes back online, it transmits not only its current (or scheduled) data, but also its previous data (or past data) that was not transmitted due to their downtime. This transmission of past data can cause multiple issues, including bandwidth management issue by loading the system with enormous amount of data. Persisting (or logging) of past data in the appropriate tables, as and when received, also adds to bandwidth concerns due to the volume of data to be processed, and may require scaling/planning of resources in the data processing pipelines. Further, when the device(s) come back online, the system may end up with incorrect system calculations due to lack of or delay of persisting and/or processing of past data. Through applied effort, ingenuity, and innovation, the inventors have solved the above problems by developing the solutions embodied in the present disclosure, the details of which are described further herein.

### SUMMARY OF THE INVENTION

In general, embodiments of the present disclosure herein provide system and method for efficient handling of temporal delays in data processing pipelines, post device reconnection. Other implementations will be, or will become, apparent to one with skill in the art upon examination of the following figures and detailed description. It is intended that all such additional implementations be included within this description be within the scope of the disclosure and be protected within the scope of the following claims.

In accordance with an embodiment of the present disclosure, an exemplary system for handling temporal delays in data processing pipeline is provided. The system comprises one or more devices which transmit data, the data comprises device status, downtime data, uptime data, metadata of the downtime data. The system also has heartbeat listener connected to the one or more devices and configured to receive the device status. The system also comprises a data loader connected to the one or more devices and persists the uptime data, a fact modeler to process the uptime data persisted by the data loader. The heartbeat listener also determines from the device status, the downtime duration of one or more devices; transmits the metadata of the downtime data associated with the downtime duration of the one or more devices to the data loader, the data loader also receives and persists the downtime data from one or more devices; and triggers the fact modeler to re-process the uptime and downtime data persisted by the data loader.

In another embodiment, the present disclosure provides a method for handling temporal delays in data processing pipeline. The method according to the present disclosure comprises transmitting data, by one or more devices, the data comprising at least one of device status, downtime data, uptime data, metadata of the downtime data; receiving, at a heartbeat listener, the device status; persisting, by a data loader, the uptime data transmitted by the one or more devices, processing, by a fact modeler, the uptime data persisted by the data loader; determining from the device status, the downtime duration of one or more devices; transmitting the metadata of the downtime data associated with the downtime duration of the one or more devices to the data loader, wherein the data loader is receiving and persisting the downtime data from one or more devices; and triggering the fact modeler to re-process the uptime and downtime data persisted by the data loader.

In yet another embodiment, the present disclosure provides a non-transitory computer-readable storage medium comprising computer program code for execution by one or more processors of an apparatus for handling temporal delays in data processing pipeline. The computer program code is configured to, when executed by the one or more processors, cause the apparatus to transmit data, by one or more devices, the data comprising at least one of device status, downtime data, uptime data, metadata of the downtime data; receive, at a heartbeat listener, the device status; persist, by a data loader, the uptime data transmitted by the one or more devices, process, by a fact modeler, the uptime data persisted by the data loader; determine from the device status, the downtime duration of one or more devices; transmit the metadata of the downtime data associated with the downtime duration of the one or more devices to the data loader, wherein the data loader is configured to receive and persist the downtime data from one or more devices; and trigger the fact modeler to re-process the uptime and downtime data persisted by the data loader.

The above summary is provided merely for the purpose of summarizing some example embodiments to provide a basic understanding of some aspects of the present disclosure. Accordingly, it will be appreciated that the above-described embodiments are merely examples and should not be construed to narrow the scope or spirit of the present disclosure in any way. It will be appreciated that the scope of the present disclosure encompasses many potential embodiments in addition to those here summarized, some of which will be further described below. Other features, aspects, and advantages of the subject will become apparent from the description, the drawings, and the claims.

### BRIEF DESCRIPTION OF THE DRAWINGS

Having thus described the embodiments of the disclosure in general terms, reference now will be made to the accompanying drawings, which are not necessarily drawn to scale, and wherein:

FIGS. 1(a) and 1(b) illustrate a block diagram of prior art system;

FIGS. 2(a) and 2(b) illustrates an exemplary block diagram of a system in accordance with the present disclosure;

FIG. 3 illustrates an exemplary block diagram of heartbeat listener module in accordance with the present disclosure;

FIG. 4 illustrates a flow chart of the steps executed by the heartbeat listener, in accordance with an embodiment of the present disclosure;

FIG. 5 illustrates a time graph comparing the prior art system and the system as per the present disclosure;

FIG. 6 illustrates another exemplary block diagram of a system in accordance with the present disclosure;

FIG. 7 illustrates a flow chart of the steps executed by the heartbeat listener, in accordance with an embodiment of the present disclosure;

FIG. 8 illustrates another exemplary block diagram of a system in accordance with the present disclosure.

FIG. 9 illustrates a flow chart of the steps executed by the heartbeat listener, in accordance with an embodiment of the present disclosure;

### DETAILED DESCRIPTION

Some embodiments of the present disclosure now will be described more fully hereinafter with reference to the accompanying drawings, in which some, but not all, embodiments of the disclosure are shown. Indeed, embodiments of the disclosure may be embodied in many different forms and should not be construed as limited to the embodiments set forth herein, rather, these embodiments are provided so that this disclosure will satisfy applicable legal requirements. Like numbers refer to like elements throughout.

As used herein, the term “comprising” means including but not limited to and should be interpreted in the manner it is typically used in the patent context. Use of broader terms such as comprises, includes, and having should be understood to provide support for narrower terms such as consisting of, consisting essentially of, and comprised substantially of.

The phrases “in one embodiment,” “according to one embodiment,” “in some embodiments,” and the like generally mean that the particular feature, structure, or characteristic following the phrase may be included in at least one embodiment of the present disclosure, and may be included in more than one embodiment of the present disclosure (importantly, such phrases do not necessarily refer to the same embodiment).

The word “example” or “exemplary” is used herein to mean “serving as an example, instance, or illustration.” Any implementation described herein as “exemplary” is not necessarily to be construed as preferred or advantageous over other implementations.

In data processing systems, there may be data pipelines that handle data coming from various connected devices each having one our more sensors. The accuracy of the processing depends on the real-time availability of the device data. However, in any enterprise, delay in receiving device data due to the devices going down, or becoming offline, is a frequent scenario. When a device comes back online, it transmits over the network not only its current (or scheduled) data, but also its previous data (or accumulated data) that was not transmitted due to the downtime. The consequence of having late arriving data in streaming pipelines and batch pipelines results in bandwidth management issues of the network. It also requires further processing of data to report accurate data because, for example, the calculations performed on any data set which was persisted into the data tables table will need to be redone. Therefore, an elaborate process needs to be initiated in data processing systems to enable the re-computation of the data, thereby creating a challenge in current systems.

Accordingly, the present disclosure provides a system that includes a heartbeat listener for efficient handling of past and current data of a device which comes back online after a downtime. The heartbeat listener ensures that any database in the data processing pipeline is timely updated to provide correct information. The heartbeat listener of the present disclosure may be implanted as a standalone module having its own processor, memory, input/output interfaces or may be implemented as an additional functionality of an existing server. Such a server may be cloud based or may be an entity specific unit. Before elaborating the implementation of the heartbeat listener in accordance with the present disclosure, it is imperative to first explain the existing (prior art) system.

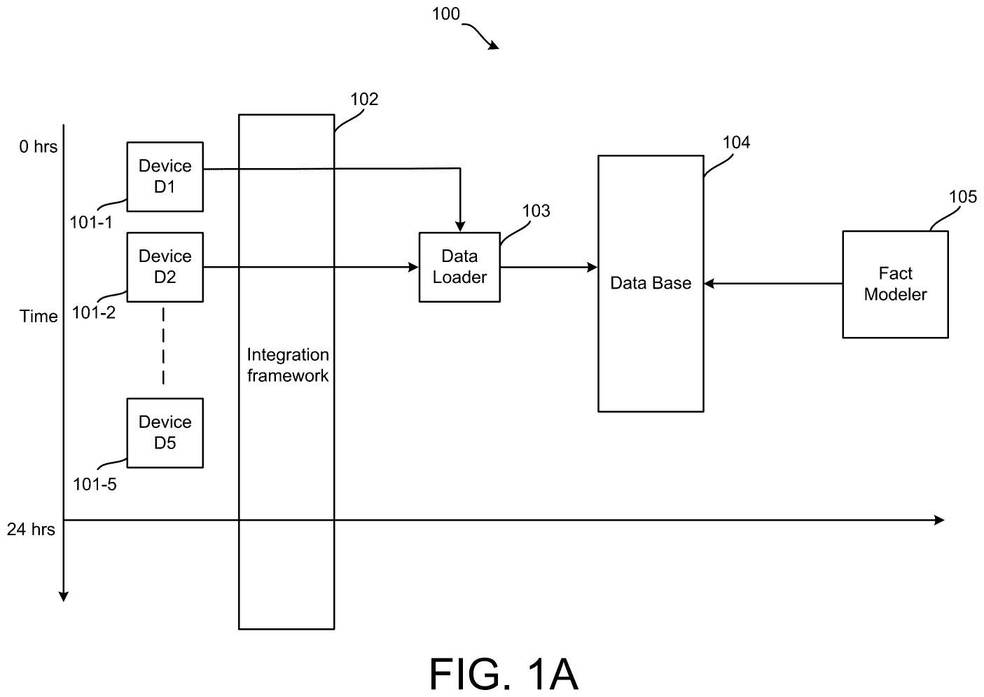

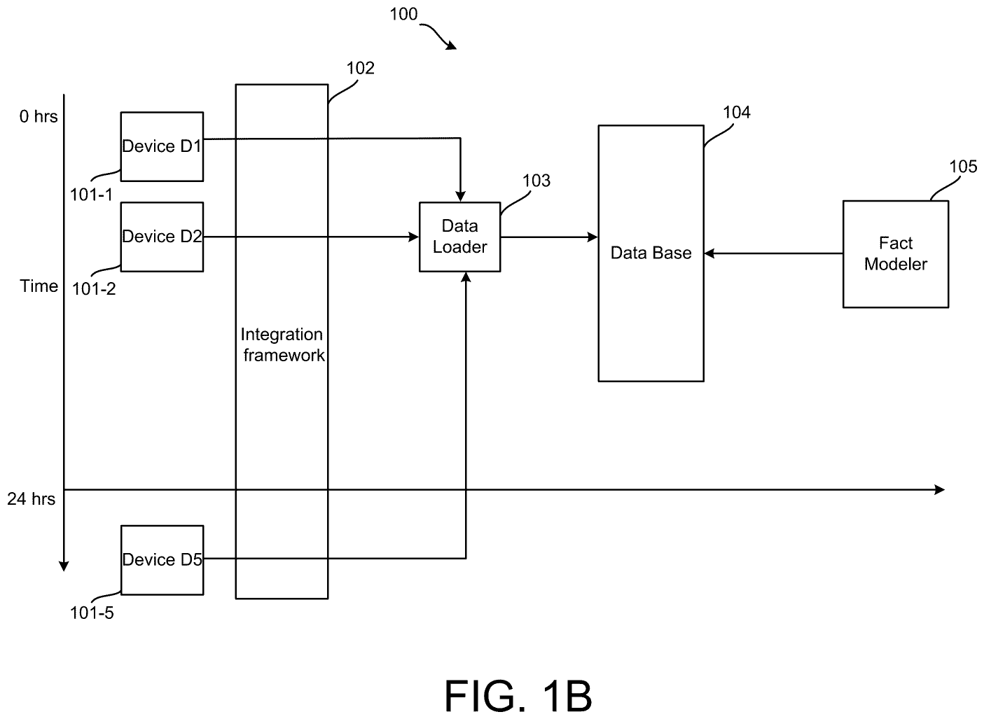

FIGS. 1(a) and 1(b) illustrates data processing pipelines in accordance with the system 100 of the prior art. In a data processing pipeline, a plurality of devices (D1, D2,D5) 101-1, 101-2 . . . 101-5, collectively referred to as 101, send their data to a data loader 103 via an Integration Framework (IF) 102. The data loader 103 obtains the data from several devices 101, performs a task of uploading the data into relevant tables of one or more databases 104. This process is also called persisting of data tables. Thereafter, a fact modeler 105 updates all the applicable entries in the database 104 based on the data persisted in relevant tables of the database 104. Typically, a data loader 103 persists data in relevant tables as and when data from the devices 101 are received. Thereafter, a fact modeler 105 performs data processing at scheduled intervals (batch processing) to ensure system efficiency. For instance, a fact modeler may run every 6 hours (i.e. 4 times in a day) to update the database. During a run, the fact modeler 105 performs processing of data persisted by the data loader and based on this processing, updates relevant entries in the database 104 to provide up to date information. In the prior art system, a data loader will update sensor readings of several devices by persisting their tables in the database. During a run, the fact modeler will then update a relevant field (e.g., average value of all sensor readings) in the database by processing the data persisted by the data loader.

In the prior art system, one or more of the plurality of devices 101 connected to the data loader 103 may go offline or get disconnected from the data loader for a variety of reasons. Such a device may remain offline for any duration of time, and after rectification of the cause leading to its disconnection, the device may again come back online. With respect to FIG. 1(a), device 101-5 is offline for a duration of 24 hours. During this period, the data that is otherwise provided to the data loader 103 for loading will get accumulated and will not be transmitted until the device 101-5 is back online. Hence, as shown in FIG. 1(b), in the prior art system, when the device 101-5 comes back online after being offline, it transmits, to the data loader 103, both the current data and its past data which was not sent earlier as the device 101-5 was offline. This large amount of past data transmitted to the data loader 103 will cause bandwidth issue due to excessive load on the network. The accumulated past data will also result in incorrect or inaccurate reporting of information by the database 104, as explained hereinafter. By way of example, in a batch processing scenario, consider that a fact modeler 105 runs every 6 hours. When the device 101-5 sends its past data (of the past 24 hours), after coming back online its past data is persisted into the relevant tables by the data loader 103. However, if the device 101-5 comes back online 1 hour after the fact modeler's 105 last run, the past data will not be processed until the next scheduled execution of the fact modeler 105, i.e. 5 hours later. Therefore, the system data in the database 104 will remain inaccurate until the next execution of the fact modeler 105 (i.e. for next 5 hours) and this may result in incorrect reporting during that timeframe.

In the prior art system, in addition to the bandwidth issues caused by the influx of data accumulated (i.e. past data) for the time period wherein a device was offline and errors in system calculations till the next scheduled execution of the fact modeler (as discussed above), the prior art system faces further difficulties associated with persisting of large volumes of past data in appropriate tables. Particularly, to efficiently persist the large volumes of past data, aligning of system resources will be required because such data could be stored on an internal disk, an external flash drive, or an array of storage devices on a network (e.g., network attached storage) and the system will need to allocate processor, memory and bandwidth resource to perform this task. However, as the context or understanding regarding the past data to be persisted is not known, the system resources cannot be suitably aligned, leading to issues related to scaling and planning. The context or understanding may be with respect to the nature of the past data, the volume of the data, the time period over which the past data was accumulated, etc. Accordingly, the scaling and planning of persisting of data into relevant tables within one or more databases may be difficult without having context regarding the past data to be persisted.

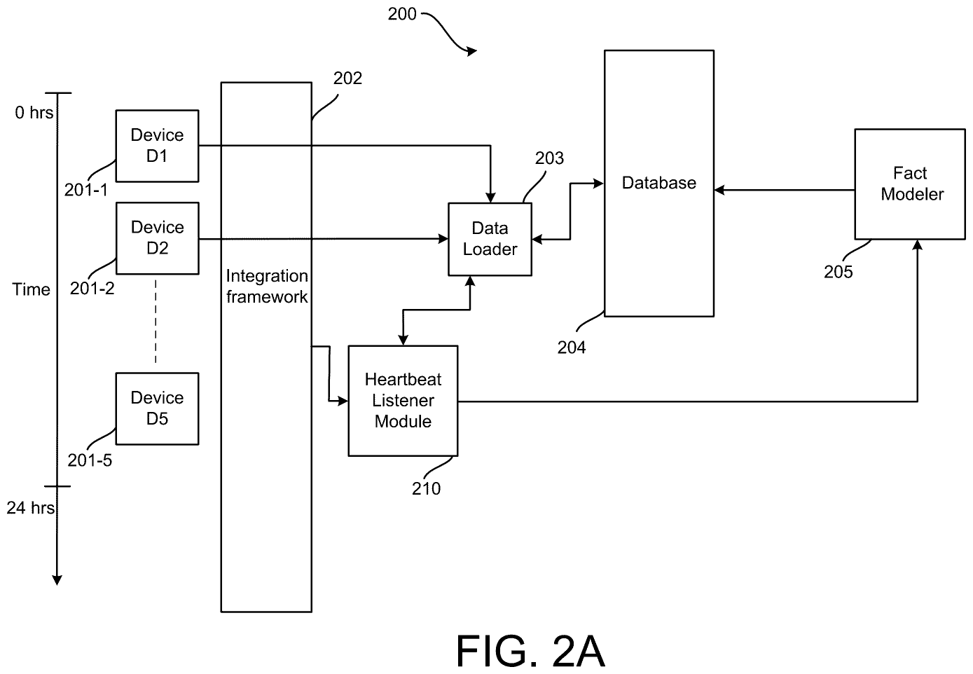

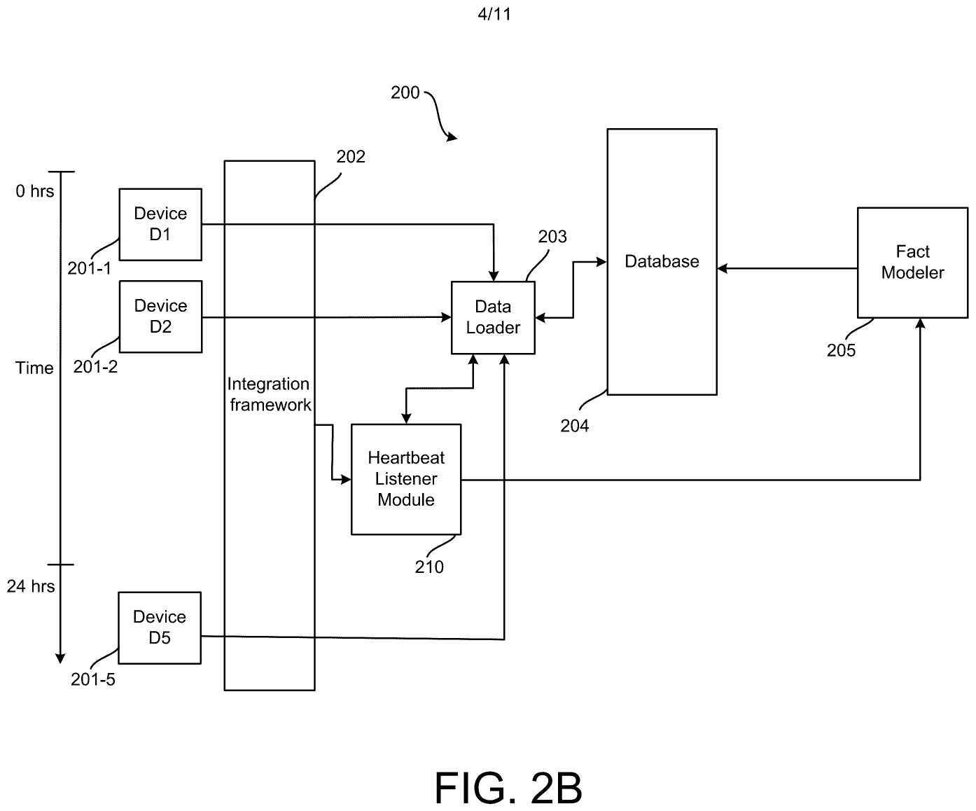

To address these problems associated with managing large volumes of past data (or downtime data) and of incorrect reporting, the present disclosure provides a system that includes a heartbeat listener module 210 in accordance with FIGS. 2(a) and 2(b). The heartbeat listener module 210 is connected to one or more devices 201-1, 201-2 . . . 201-n, collectively labelled as 201, via an integration framework (IF) 202. In another embodiment, the heart beat module's 210 connection with the one or more devices 201-1, 201-2 . . . 201-n may also be a direct connection without any integration framework (IF) 202. In a still alternative embodiment, connection with some devices 201-1, 201-2 . . . 201-n is via the integration framework (IF) 202 and with other devices be a direct connection. The heartbeat listener module 210 is also operatively connected to a data loader 203. The heartbeat listener module 210 receives real-time information regarding the health status of the devices 201 as well as metadata of the data sent by the devices to a data loader 203. The devices 201 are operatively connected to the data loader 203, and the data loader 203 is used for persisting the data collected from the devices 201 into relevant tables in one or more databases 204. A fact modeler 205 updates all the applicable entries in the database 204, based on the data persisted in relevant tables of the database 204.

As per the present disclosure, the heartbeat listener module 210 keeps on tracking the device health status of the one or more connected devices 201 and takes no further action as long as the devices 201 are working properly and are online. The tracking by the heartbeat listener module 210 for each one of the devices 201 can be based on unique identifier of each device. The unique identifier, is a specific code or number that is assigned to a device. It serves as a distinctive identification for the device and is unique to each individual device such that, every device has a unique identifier that distinguishes it from other devices. The tracking by the heartbeat listener module 210 for each one of the devices 201 may be performed by one or more of: directly checking health status of the devices, checking the type of data (present or past) the devices are transmitting, getting device health status update from a database etc. In a scenario of a device 201-5 getting disconnected or experiencing downtime, this is shown with reference to FIG. 2(a) where there is no operative connection between device 201-5 and the data loader 203, no transmission of data is taking place. However, the heartbeat listener module 210 continues to track the health status of the device 201-5.

When the device 201-5 is back online, as shown with reference to FIG. 2(b) where there is an operative connection between device 201-5 and the data loader 203, a separate signal is sent to the heartbeat listener module 210. When a device (201-5 as per FIG. 2(a)) goes offline and after the device 201-5 comes back online (201-5 as per FIG. 2(b)), the heartbeat listener module 210 takes note of the duration for which the device 201-5 went offline, based on the signals obtained from the IF 202. Further, the heartbeat listener module 210 receives metadata from the device 201-5 providing details of the downtime data that the device 201-5 is (or will be) sending to the data loader 204. The downtime data that the device 201-5 sent to the data loader 203 includes the data aggregated during a period for which the device 201-5 was offline. The metadata related to the device 201-5 sent by the heartbeat listener module 210 to the data loader 203 may contain a device unique identifier, device down time span (from start time to end time), device up time, amount of data in disk, number of records, flow rate etc. The metadata transmitted to data loader 203 may contain additional information like the time that will be needed to persist this past data to the relevant tables in the database 204. In the given embodiment, the metadata is transmitted by the device 201-5 to the heartbeat listener module 210, which is then forwarded by the heartbeat listener module 210 to the data loader 203. In another embodiment, the metadata may be directly transmitted by the device 201-5 to the data loader 203, based on instructions given by the heartbeat listener module 210. In an alternative embodiment, one or more details of the metadata may be computed by the heartbeat listener module 210 and then the metadata received from the device 201-5 along with the computed metadata may be forwarded to the data loader 203 as the metadata from the heartbeat listener module 210. In a still alternative embodiment, computation of the time need for persisting may be done by the data loader 203 based on the metadata received.

In a given instance, as represented by the FIG. 2(b), the device may become online after 24 hours. On receiving the signal, the heartbeat listener module 210 provides the data loader 203 with a metadata regarding the past data accumulated over 24 hours by device 201-5. The metadata received by the data loader 203 may contain context as to the nature and properties of the data being sent (to be sent) by each of the devices 201, and is used by the data loader 203 for the persisting of the data into relevant tables of the database 204. In the prior art system, the data loader performs the persisting of the past data into relevant tables of the database but does not have any context regarding the nature and properties of past data. However, as per the present disclosure, since the data loader 203 also has the metadata received from the heartbeat listener module 210, it performs the persisting more efficiently, since the metadata provides context as to the nature and properties of data obtained from a device by the data loader 203. Particularly, as relevant details like volume of past data, time needed for persisting the past data, are known, the persisting activity of the past data can be suitably planned and scheduled so as to reduce load on resources of the system and/or perform the persisting activity more swiftly. Depending on the system requirements, the persisting of tables may be delayed or prolonged in a catchup phase, thus allowing optimum utilization of system resources. In this regard, unlike the system of the prior art which performs the persisting activity of the past data, as soon as the past data is received and thus may overload the system in case the volume of the past data is huge; as per the present system, as the metadata is available with the data loader 203 it may perform the persisting activity of the past data in a phased manner thus reducing the load on the system resources. Alternatively, persisting of tables with the past data of the device 201-5 may be performed on priority and even additional system resources may be deployed for swift persisting of this past data. Further, as the metadata information is available with the data loader 203 and expected volume of data is known, bandwidth management can also be performed more efficiently. Still further, in view of the metadata information, resource planning at subsequent stages of the data processing pipeline can be performed efficiently.

As per the present disclosure, the heartbeat listener module 210 not only provides metadata to data loader but also ensures accuracy of the system data. As discussed in the working of the prior art system, even after the persisting of tables is performed by the data loader, the facts modeler will not be run until its next scheduled cycle and until then the system data will be inaccurate. To address this problem, an embodiment the present disclosure provides that once data loader 203 has completed persisting of past data of a device (device 201-5 as per FIG. 2(a)) that was offline for a certain period of time, it sends a feedback to the heartbeat listener module 210 confirming the completion of the persisting activity. Based on this feedback, the heartbeat listener module 210 can send a trigger for execution of the fact modeler 205 to update the system with correct and accurate data. Such execution of the fact modeler 205 based on a trigger provided by the heartbeat listener module 210 can be independent of its scheduled execution, and ensures correction of system data in a prompt manner without delays. This implementation of the heartbeat listener module 210 is explained further by way of a working example.

In an embodiment of the present disclosure in accordance with FIGS. 2(a) and 2(b), a device may come back online after 24 hours of being offline and send data, wherein the data includes current data (i.e. uptime data) and data accumulated (i.e. downtime data) over a 24-hour offline period. As per the present disclosure, the heartbeat listener determines the downtime duration of the device based on the device status. Also, metadata of the downtime data will be sent to the heartbeat listener module 210 and the heartbeat listener module 210 further provides the metadata to the data loader 203. The data loader 203 performs persisting of data obtained from the device efficiently in view of the metadata received. Thereafter, data loader 203 sends a feedback to the heartbeat listener module 210 regarding the completion of the persisting of tables in the database 204. Based on this feedback provided by the data loader 203, the heartbeat listener triggers execution of the fact modeler 205 and thus ensures that system gets updated with accurate data timely. Similar to the example discussed above regarding the prior art system, even if the scheduled execution of the fact modeler is after 5 hours, the system data will not remain inaccurate for next 5 hours, rather based on the feedback received from data loader 203, the heartbeat listener 210 will trigger an unscheduled execution of the fact modeler 205 and this ensures that system data is timely updated and is accurate.

This unscheduled execution of fact modeler may be a full execution, as would have happened at a scheduled execution or may be for a few fields only, as are impacted by the past data. Further, the unscheduled execution may even change the cycle of future scheduled executions of the fact modeler or future executions may remain unchanged. Present discourse is not limited by such modification and execution of fact modeler.

As per the present disclosure, the heartbeat listener improves the system performance by ensuring that device metadata is provided to the data loader 203, which thus provides improved bandwidth management as well as planned persisting of past data. Further, as device metadata is available with heartbeat listener module 210, scaling/planning of resources in the data processing pipeline can be done efficiently. Furthermore, the heartbeat listener module 210 also ensures that system calculations are valid and current by triggering re-run of system calculations, by fact modeler 205, upon persisting of past data.

In certain embodiments, the heartbeat listener module 210 may provide the trigger to the fact modeler 205 without the need of confirmation from the data loader 203. In such embodiments, the heartbeat listener module 210 may use the metadata regarding the past data to generate an approximation of the time required for persisting by the data loader 203, and the approximation may also be assisted by knowledge of resources available to persisting the past data. Hence, on crossing the time approximated by the heartbeat listener module 210 measured from the time of sending metadata to the data loader, the heartbeat listener module 210 may send the trigger to the fact modeler 206 by itself, thus avoiding the feedback from the data loader 203, as illustrated in FIG. 2a and FIG. 2b.

In an embodiment of the present disclosure, multiple devices 201 may experience downtime at any instance and may come back online at the same time (not shown in FIG. 2). The heartbeat listener 210 will monitor such multiple devices 201 and when the devices 201 back online, they will start sending their past data to the data loader 203. The heartbeat listener 210 will receive metadata for such multiple devices 201 and will provide the same to the data loader 203. In an embodiment, the data loader 203 will perform persisting of past data of these multiple devices 201 based on the metadata received. The data loader 203 may perform the data persisting for these multiple devices 201 simultaneously, as and when their past data is received. In an alternative embodiment, the persisting of data of one device may be prioritized over the other devices. Such priority may be given based on the volume of data to be persisted, relevance of the data, availability of the system resources, availability of bandwidth etc. Once persisting of past data of one of the devices is completed, the data loader 203 may send the feedback to the heartbeat listener 210. Based on the feedback received, the heartbeat listener 210 may trigger a run of the fact modeler 205. Thereafter, once persisting of past data of the other device is completed, feedback regarding the same is provided to the heartbeat listener 210. Based on this feedback the heartbeat listener 210 may trigger another run of the fact modeler 205. In an alternative embodiment, as the heartbeat listener 210 is aware that the data loader 203 is persisting past data of multiple devices, the heartbeat listener 210 may delay the trigger to the fact modeler 205. Particularly, instead of triggering fact modeler 205 upon completion of persisting of past data of the first device, the heartbeat listener 210 will trigger the run of the fact modeler 205 after completion of persisting of past data of all the multiple devices 201. This will avoid multiple run of the fact modeler 205 and hence, improve system efficiency. In a still alternative embodiment, the run of the fact modeler 205 may be triggered upon completion of persisting of data of only some of the multiple devices.

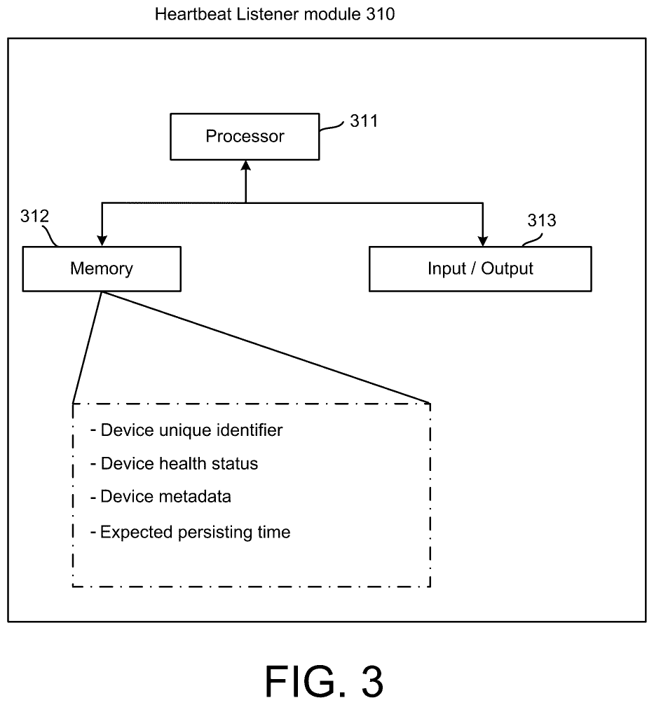

FIG. 3 illustrates an exemplary block diagram of heartbeat listener module 310, in accordance with the embodiment of FIG. 1 of the present disclosure. The heartbeat listener module 310 comprises a processor 311, a memory 312, and an input/output unit 313. The processer 311 of the heartbeat listener module is used for executing instructions stored within the memory 312. Processor may be embodied in a number of different ways. In various embodiments, the use of the terms “processor” should be understood to include a single core processor, a multi-core processor, multiple processors and/or one or more remote or “cloud” processor(s). In some example embodiments, processor may include one or more processing devices configured to perform independently. In some embodiments, the processor 311 includes hardware, software, firmware, and/or a combination thereof that performs one or more operations described herein. The processor 311 may be configured to execute instructions stored in the memory 312 or otherwise accessible to the processor. Alternatively, the processor 311 may be configured to execute hard-coded functionality. As such, whether configured by hardware or software methods, or by a combination thereof, processor 311 may represent an entity (e.g., physically embodied in circuitry) capable of performing operations according to embodiments of the present disclosure while configured accordingly. Alternatively, the processor 311 may be embodied as an executor of software instructions, and the instructions may specifically configure the processor 311 to perform the various algorithms embodied in one or more operations described herein when such instructions are executed. In some embodiments, the processor 311 includes hardware, software, firmware, and/or a combination thereof that performs one or more operations described herein. In some embodiments, the processor 311 (and/or co-processor or any other processing circuitry assisting or otherwise associated with the processor) is/are in communication with the memory 312 via a bus for passing information among components of the heartbeat listener module 310.

The instructions stored in the memory 312 include instructions for receiving inputs from one or more devices, instructions for transmitting metadata to the data loader, and instructions for triggering processing of persisted data by the fact modeler. The memory 312 may also be used for storing the inputs received from one or more devices, wherein the inputs included device status and device metadata of the devices connected to the heartbeat listener module 310. Further, the memory 312 may also store information including the unique identifier of devices and expected persisting time. In an embodiment, the memory 312 of the heartbeat listener module 310 may be located remotely, such as on a cloud-based server or a local server, and be operatively connected to the data processing pipeline. Memory 312 may be non-transitory and may include, for example, one or more volatile and/or non-volatile memories. In some embodiments, the memory 312 includes or embodies an electronic storage device (e.g., a computer readable storage medium). In some embodiments, the memory 312 is configured to store information, data, content, applications, instructions, or the like, for enabling heartbeat listener module 310 to carry out various operations and/or functions in accordance with example embodiments of the present disclosure.

The input/output unit 313 of the heartbeat listener module 310 is used for receiving device status and metadata, confirmation notification from the data loader on completion of persisting of data, and for sending metadata to the data loader and trigger signal to the fact modeler for initiating its execution. In another embodiment, the heartbeat listener module 310 may be a standalone device which may be plugged into an existing system to perform data processing in accordance with the present disclosure. In another embodiment, the heartbeat listener module 310 maybe hosted by other components of the system such as the data loader, fact modeler etc. The input/output unit 313 may be in communication with the processor 311 to provide such functionality. The input/output unit 313 may comprise one or more user interface(s). In some embodiments, a user interface may include a display that comprises the interface(s) rendered as a web user interface, an application user interface, a user device, a backend system, or the like. In some embodiments, the input/output unit 313 also includes a keyboard, a mouse, a joystick, a touch screen, touch areas, soft keys a microphone, a speaker, or other input/output mechanisms. The processor 311 and/or input/output unit 313 comprising the processor may be configured to control one or more operations and/or functions of one or more user interface elements through computer program instructions (e.g., software and/or firmware) stored on a memory accessible to the processor (e.g., memory 312, and/or the like). In some embodiments, the input/output unit 313 includes or utilizes a user-facing application to provide input/output functionality to a computing device.

Working of the heartbeat listener module 310 is now explained. The heartbeat listener module 310 receives device status and metadata via its input/output unit 313. The heartbeat listener module 310 transmits a device's metadata to a data loader, when the device comes back online (i.e. based on the device status) and is transmitting its past data. The heartbeat listener module 310 then receives feedback from the data loader, after the data loader has completed persisting of past data. The heartbeat listener module 310 is also connected to a fact modeler via its input/output unit 313 and the heartbeat listener module 310 can trigger a run of the fact modeler. Further, heartbeat listener module 310 may even receive confirmation from the fact modeler regarding its successful run and hence, the heartbeat listener module 310 is aware that the system data is UpToDate.

In an embodiment, one or more modules (not shown) of the system may be implemented using electronic hardware, computer software, or any combination thereof. Whether such elements are implemented as hardware or software depends upon the application and design constraints imposed on the overall system. Examples of the systems may include computing systems (e.g., servers, datacenters, desktop computers, Internet of Things devices, etc.) and mobile computing systems (e.g., laptops, cell phones, etc.). Although components are described with respect to functional limitations, it should be understood that the particular implementations necessarily include the use of particular computing hardware. It should also be understood that in some embodiments certain of the components described herein include similar or common hardware.

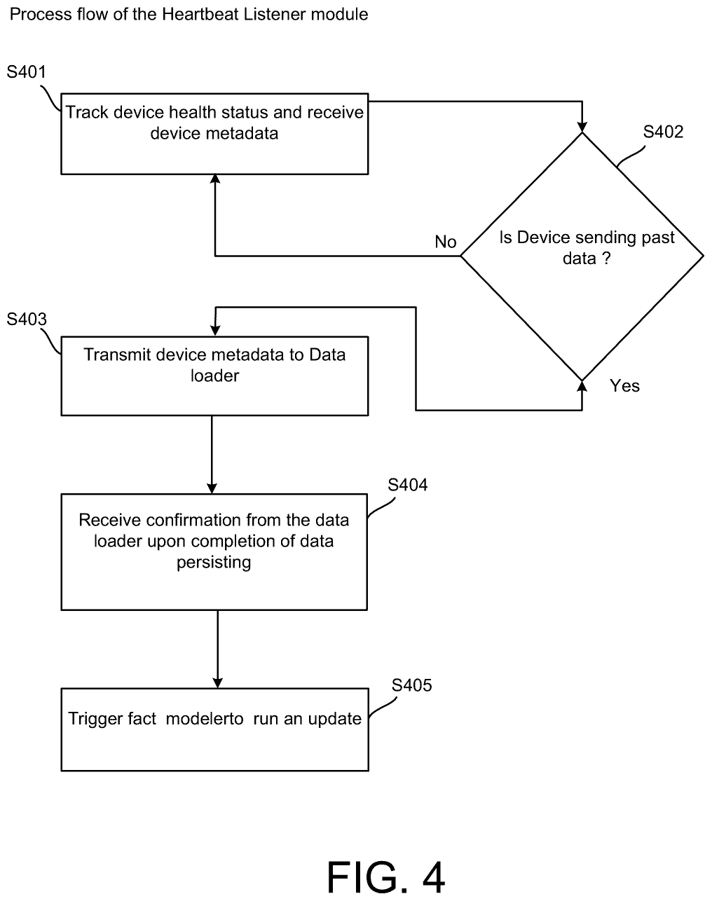

FIG. 4 illustrates an exemplary flow chart of the steps executed by the heartbeat listener module, in accordance with the embodiment of FIG. 2 of the present disclosure. The heartbeat listener module performs tracking of the health status of a plurality of connected devices. When one of the devices goes offline, the heartbeat listener executes step S401, wherein S401 involves tracking of the health status of the device till the device comes back online to obtain duration of downtime, and thereafter receives the metadata from the device. In a given embodiment, the heartbeat listener can directly track health status of the devices by monitoring uptime and down time of the device. Such monitoring can be based on a connection with the device via the IF (Integration Framework). Alternatively, the device status can be obtained from a repository where the device status is regularly updated. In an alternate embodiment, the device status of all the devices are collected, combined together and is then provided to the heartbeat listener as an update at regular intervals. In an alternate embodiment, the health status of different devices is provided to the heartbeat listener in a combination of one or more of the above listed communications.

In step S402, it is determined if the device is sending the past data or not. In a given embodiment, such determination can be made based on the device health status, as a device sends its past data immediately upon coming back online. Alternatively, such determination can be made based on metadata received from the device. Still alternatively, the data loader may inform the heartbeat lighter that the device is sending the past data. Till it is determined that the device is sending past data, the heartbeat listener continues to track the device health status. The tracking by the heartbeat listener module for each one of the devices can be based on unique identifier of each device. The unique identifier, is a specific code or number that is assigned to a device. It serves as a distinctive identification for the device and is unique to each individual device such that, every device has a unique identifier that distinguishes it from other devices. The tracking by the heartbeat listener module for each one of the devices may be performed by one or more of: directly checking health status of the devices, checking the type of data (present or past) the devices are transmitting, getting device health status update from a database etc.

Based on the determination that the device is sending past data, the heartbeat listener module executes step S403 involving the transmission of the metadata to the data loader. The metadata is received from the device may include a device unique identifier, device down time span (from start time to end time), device up time, amount of data in disk, number of records, flow rate etc. Accordingly, at this step S403, the metadata, providing context regarding the past data being transmitted by the device, is provided to the data loader. Based on the metadata provided, the data loader performs the persisting more efficiently, since the metadata provides context as to the nature and properties of data obtained from a device by the data loader. Particularly, as relevant details like volume of past data, time needed for persisting the past data, are known, the persisting activity of the past data can be suitably planned and scheduled so as to reduce load on resources of the system and/or perform the persisting activity more swiftly. Depending on the system requirements, the persisting of tables may be delayed in a catchup phase, thus allowing optimum utilization of system resources, or alternatively, persisting of tables with the past data of the device may be performed on priority and even additional system resources may be deployed for swift persisting of this past data. Further, as the metadata information is available with the data loader and expected volume of data is known, bandwidth management can also be performed more efficiently.

After transmission of metadata to the data loader, the heartbeat listener module waits for a confirmation from the data loader of completion of data persisting to relevant tables of the database in step S404. As per the present disclosure, the data loader performs the persisting more efficiently, since the metadata provides context as to the nature and properties of data obtained from the device.

On receiving confirmation, the heartbeat listener module executes step S405 involving sending a trigger to the fact modeler for execution of an update. Particularly, the heartbeat listener module triggers execution of the fact modeler to update the system with correct and accurate data. Such execution of the fact modeler based on a trigger provided by the heartbeat listener module can be independent of scheduled executions of the fact modeler and this ensures that system gets updated with accurate data timely. Accordingly, even if the scheduled execution of the fact modeler is much later, the system data will not remain inaccurate till next scheduled execution of the fact modeler, rather based on the feedback received from the data loader, the heartbeat listener will trigger an unscheduled execution of the fact modeler and this ensures that system data is timely updated and is accurate. This unscheduled execution of fact modeler may be a full execution, as would have happened at a scheduled execution or may be for a few fields only, as are impacted by the past data. Further, the unscheduled execution may even change the cycle of future scheduled executions of the fact modeler or future executions may remain unchanged. Furthermore, the heartbeat listener module may even receive confirmation from the fact modeler regarding its successful run and hence, the heartbeat listener module is aware that the system data is UpToDate.

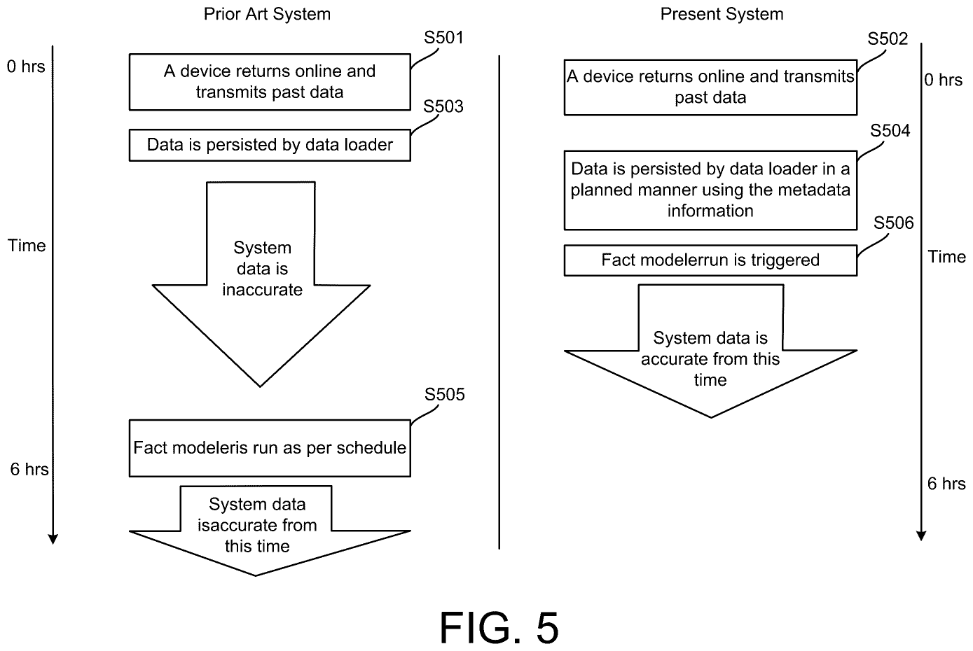

Due to the dual functionality provided by the heartbeat listener, the present system exhibits an increased efficiency as compared to the system provided in the prior art. Particularly, the present system is directed towards efficient persisting of data by the data loader based on metadata provided by heartbeat listener, wherein the metadata provides relevant insights regarding the past data that the device is (or will be) sending upon coming back online after being offline for some period of time. Additionally, in the present system the heartbeat listener triggers execution of the fact modeler based on a feedback that is provided by the data loader to the heartbeat listener. FIG. 5 illustrates the temporal efficiency of the present system as compared to the system provided in the prior art. The operation of prior art system and the present system is compared over a time period which, for the purpose of an exemplary comparison is 6 hours (FIG. 5). In both the prior art system and the present system, the past data of a device, accumulated due to the device being offline, is transmitted to a data loader once the device comes back online, as represented by steps S501 and S502 respectively. The time of execution of steps S501 and S502 may be similar, as execution of this step in both systems depend on the event of a device coming back online and they past data accumulated by the device, and is not dependent on any inherent component or functioning of the prior art system or the present system.

As illustrated in FIG. 5, in the prior art system after the device comes online and past data is transmitted by the device to the data loader as per step S501, the past data is persisted by the data loader to relevant tables of a database at a step S503. The past data of the device may be extensive and voluminous in nature depending on the type of the past data and the time period for which the device was offline etc. Hence, the persisting of past data by the data loader may take a long time in the prior art system, and may also lead to overloading and possible failure of resources used for persisting data to the database. This large amount of past data transmitted to the data loader will cause bandwidth issue due to excessive load on the network. The accumulated past data will also result in incorrect or inaccurate reporting of information by the database. The abovementioned issues associated with persisting of past data of a device into relevant tables of a database is avoided in the present system by use of a heartbeat listener module as per step S504.

At step S504, the heartbeat listener module provides metadata regarding the past data of the device, and the metadata provides a context regarding the nature and properties of the past data to the data loader, thereby aiding the data loader in persisting the past data to the database. The context may be with respect to the nature of the past data, the volume of the data, the time period over which the past data was accumulated, etc. The heartbeat listener module may receive the metadata regarding the past data of the device directly from the device or through an interface like an integrated framework. The metadata includes information such as device down time span, device up time, amount of data in disk, number of records, and flow rate. Such information provides insight to the data loader regarding the type and number of resources required for persisting the past data into the database, and hence assists in the planning of persisting of data by the data loader. The information included within the metadata may also provide context as to the priority of the past data, depending on which the persisting of past data may be spanned out over a period of time based on available resources or speed up by committing additional resources to data persisting. Hence execution of step S504 by the present step enables a more efficient persisting of past data into the database as compared to step S503 of the prior art system.

As illustrated in FIG. 5, in the prior art system despite persisting of past data into the relevant tables of the database, there may be inaccurate data within different fields, reports, or tables of databases, as fact modeler updates may still be pending. Such an error may arise despite successfully persisting of past data into the database, as context regarding delay in arrival of the past data may be unknown to other systems using the database. The database may be used by other resources as representing the latest data in the operations or processing, thereby leading to inaccurate values within the databases of the prior art system. These inaccurate values remain in the database until a fact modeler executes its operation for updating the databases as per step S505. In the prior art system, fact modeler is executed based on a fixed schedule or scheduling cycle. For instance, if the schedule of the fact modeler is fixed for updating operations every 6 hours, the update operation is performed accordingly, irrespective of when past data is persisted to the database. Hence, the inaccurate values will remain in the databases till the next scheduled update is conducted by the fact modeler. For example, consider that a fact modeler runs every 6 hours. So, if a device comes back online 1 hour after the fact modeler's last run, the past data will not be processed until the next scheduled execution of the fact modeler, i.e. 5 hours later. Therefore, the system data in the database will remain inaccurate until the next execution of the fact modeler (i.e. for next 5 hours) and this may result in incorrect reporting during that timeframe.

The issue arising with respect to pendency of inaccurate data in the databases due to scheduled updating cycles is avoided in the present system using the heartbeat listener module as per step S506. The heartbeat listener module receives a confirmation from the data loader on completion of persisting of the past data, and on receiving the confirmation, the heartbeat listener module sends a trigger to the fact modeler to initiate the update operation of the databases. The trigger sent by the heartbeat listener module may be a notification, signal, flag etc., and trigger would result in the initiation of the update operation by the fact modeler irrespective and independent of its scheduled update cycle. The update operation by the fact modeler will be carried out regardless of the last update conducted as per the scheduled update cycle, and depends solely on the trigger received from the heartbeat listener module. The step S506 thereby ensure that inaccurate data resulting from persisting of past data into the database is handled and corrected as and when the persisting of past data is completed, and prevents inaccurate data from remaining within the databases used by the present system.

Hence, the time taken for obtaining accurate data based on past data from a device which had gone offline is considerably reduced in the present system by use of a heartbeat listener module as compared to the prior art system. In the instance as illustrated in FIG. 5, the timeline of obtaining accurate data is effectively and significantly reduced as compared to 6 hours' time taken by the prior art system for rectification of the inaccurate data. For instance, if the persisting of data is completed at 1-hour instance, in the prior art system, the database will remain inaccurate till next execution of fact modeler, i.e. for next 5 hours. On the other hand, as per the present system, if the persisting of data is completed at 1-hour instance, the update by fact modeler is instantaneously triggered by the fact modeler and database will not remain inaccurate. While the above disclosure has mentioned the triggering of fact modeler, by the heartbeat listener, immediately upon completion of persisting of data by the data loader, it is still possible to delay fact modeler update for better utilization of system resources.

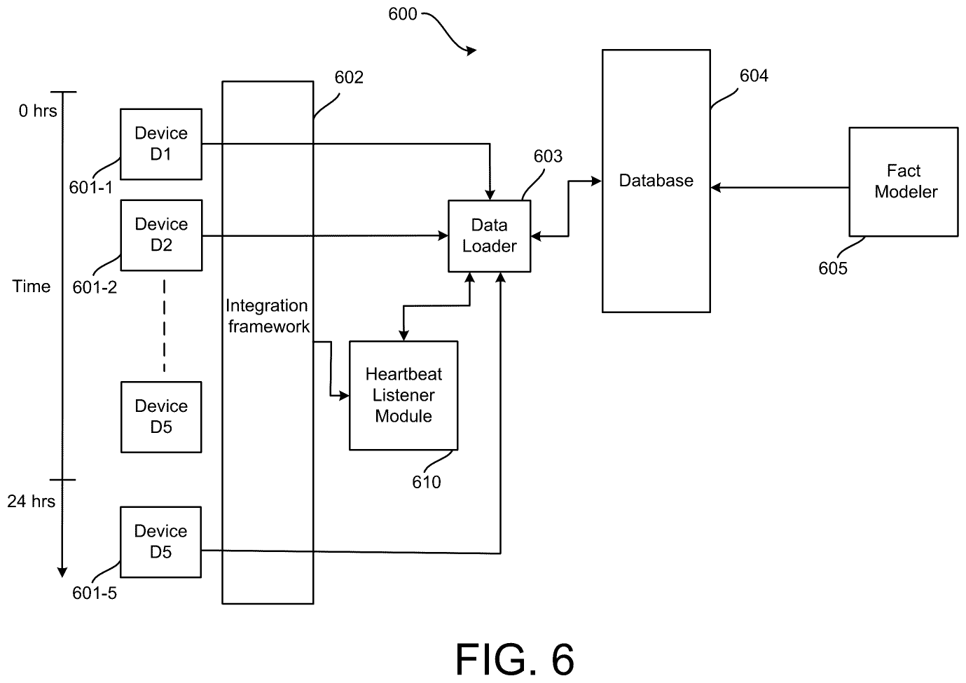

As per another embodiment of the present invention, the present system may be used only for efficiently managing the loading of data into relevant tables of a database using a data loader based on metadata, as illustrated in FIG. 6. The system may be used for efficient loading of past data accumulated over a period wherein a device was offline. With respect to FIG. 6, device 601-5 was offline for a period of 24 hours, and upon coming online, the vast amount of accumulated data is to be handled so as to ensure that resources of the system are not overloaded. The heartbeat listener module 610 connected to the device 601-5, along with a plurality of other devices 601, is used for providing metadata related to the past data of device 601-5 to the data loader 603. The metadata is generated by the device 601-5, and is provided to the heartbeat listener module 610. The metadata is thereafter provided to the data loader 603 as an output of the heartbeat listener module 610, and the metadata provides context as to the nature and properties of the past data accumulated in the device 601-5.

The metadata related to the device 601-5 sent by the heartbeat listener module 610 to the data loader 603 may contain a device unique identifier, device down time span (from start time to end time), device up time, amount of data in disk, number of records, flow rate etc. The metadata transmitted to data loader 603 may contain additional information like the time that will be needed to persist this past data to the relevant tables in the database 604. In the given embodiment, the metadata is transmitted by the device 601-5 to the heartbeat listener module 610, which is then forwarded by the heartbeat listener module 610 to the data loader 603. In another embodiment, the metadata may be directly transmitted by the device 601-5 to the data loader 603, based on instructions given by the heartbeat listener module 610. In an alternative embodiment, one or more details of the metadata may be computed by the heartbeat listener module 610 and then the metadata received from the device 601-5 along with the computed metadata may be forwarded to the data loader 603 as the metadata from the heartbeat listener module 610. In a still alternative embodiment, computation of the time need for persisting may be done by the data loader 603 based on the metadata received. Depending on the system requirements, the persisting of tables may be delayed or prolonged in a catchup phase, thus allowing optimum utilization of system resources. Alternatively, persisting of tables with the past data of the device 601-5 may be performed on priority and even additional system resources may be deployed for swift persisting of this past data. Further, as metadata information is available with the data loader 603 and expected volume of data is known, bandwidth management can also be performed more efficiently. Still further, the metadata also aids in scaling and planning the manner in which the past data and the current data generated by the device 601-5 is to be persisted in the relevant tables of the database 604. Such a strategic approach of loading data to the database 604 is required to ensure that the vast amount of data generated by the device 601-5 as a cumulative effect of past and current data does not create unnecessary load on the resources of the system.

The approaches adopted based on metadata received from the heartbeat listener module 610 include either spacing the loading of data over a period of time, or prioritizing the loading of data based on relevance of data by committing more resources to the loading of data to the relevant tables. The metadata helps in this process as the metadata include relevant information such as device down time span, device up time, amount of data in disk, number of records, and flow rate. In the prior art system, the data loader performs the persisting of the past data into relevant tables of the database but does not have any context regarding the nature and properties of past data. However, as per the present disclosure, since the data loader 603 also has the metadata received from the heartbeat listener module 610, it performs the persisting more efficiently, since the metadata provides context as to the nature and properties of data obtained from a device by the data loader 603. Particularly, as relevant details like volume of past data, time needed for persisting the past data, are known, the persisting activity of the past data can be suitably planned and scheduled.

In an embodiment of the present disclosure, multiple devices 601 may experience downtime at any instance and may come back online at the same time (not shown in FIG. 6). The heartbeat listener 610 will monitor such multiple devices 601 and when the devices 601 back online, they will start sending their past data to the data loader 603. The heartbeat listener 610 will receive metadata for such multiple devices 601 and will provide the same to the data loader 603. In an embodiment, the data loader 603 will perform persisting of past data of these multiple devices 601 based on the metadata received. The data loader 203 may perform the data persisting for these multiple devices 201 simultaneously, as and when their past data is received. In an alternative embodiment, the persisting of data of one device may be prioritized over the other devices. Such priority may be given based on the volume of data to be persisted, relevance of the data, availability of the system resources, availability of bandwidth etc. Once persisting of past data of one of the devices in completed, the data loader 203 may send the feedback to the heartbeat listener 210. Alternatively, the data loader 203 may send the feedback to the heartbeat listener 210 upon completion of persisting of past data of multiple devices.

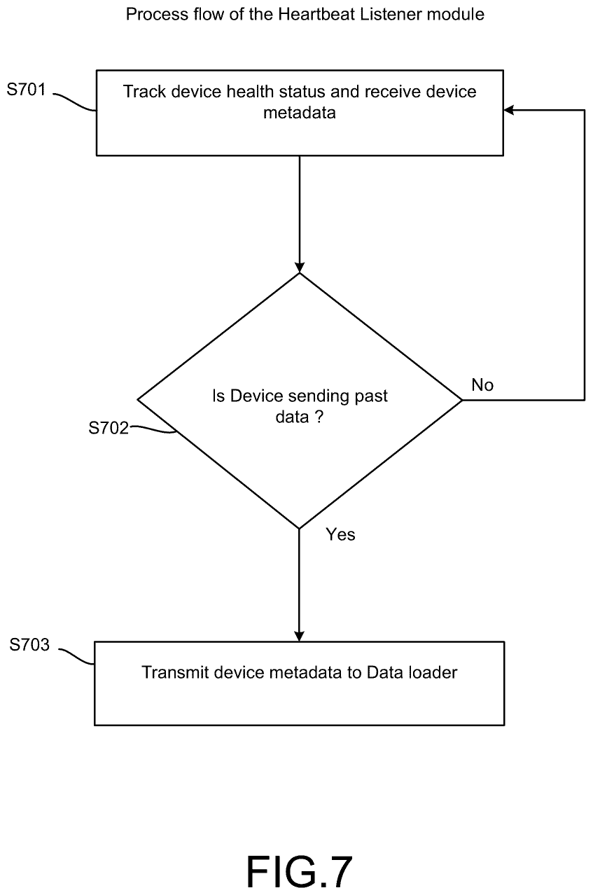

FIG. 7 illustrates an exemplary flow chart of the steps executed by the heartbeat listener module, in accordance with the embodiment of FIG. 6 of the present invention. The heartbeat listener module performs tracking of the health status of a plurality of connected devices. When one of the devices goes offline, the heartbeat listener executes step S701, wherein S701 involves tracking of the health status of the device till the device comes back online to obtain duration of downtime, and thereafter receives the metadata from the device. In a given embodiment, the heartbeat listener can directly track health status of the devices by monitoring uptime and down time of the device. Such monitoring can be based on a connection with the device via the IF (Integration Framework). Alternatively, the device status can be obtained from a repository where the device status is regularly updated. In an alternate embodiment, the device status of all the devices are collected, combined together and is then provided to the heartbeat listener as an update at regular intervals.

In step S702, it is determined if the device is sending the past data or not. In a given embodiment, such determination can be made based on the device health status, as a device sends its past data immediately upon coming back online. Alternatively, such determination can be made based on metadata received from the device. Still alternatively, the data loader may inform the heartbeat lighter that the device is sending the past data. Till it is determined that the device is sending past data, the heartbeat listener continues to track the device health status. The tracking by the heartbeat listener module for each one of the devices can be based on unique identifier of each device. The unique identifier, is a specific code or number that is assigned to a device. It serves as a distinctive identification for the device and is unique to each individual device such that, every device has a unique identifier that distinguishes it from other devices. The tracking by the heartbeat listener module for each one of the devices may be performed by one or more of: directly checking health status of the devices, checking the type of data (present or past) the devices are transmitting, getting device health status update from a database etc.

Based on the determination that the device is sending past data, the heartbeat listener module executes step S703 involving the transmission of the metadata to the data loader. The metadata is received from the device may include a device unique identifier, device down time span (from start time to end time), device up time, amount of data in disk, number of records, flow rate etc. Accordingly, at this step S703, the metadata, providing context regarding the past data being transmitted by the device, is provided to the data loader. Based on the metadata provided, the data loader performs the persisting more efficiently, since the metadata provides context as to the nature and properties of data obtained from a device by the data loader. Particularly, as relevant details like volume of past data, time needed for persisting the past data, are known, the persisting activity of the past data can be suitably planned and scheduled so as to reduce load on resources of the system and/or perform the persisting activity more swiftly. Depending on the system requirements, the persisting of tables may be delayed in a catchup phase, thus allowing optimum utilization of system resources, or alternatively, persisting of tables with the past data of the device may be performed on priority and even additional system resources may be deployed for swift persisting of this past data. Further, as the metadata information is available with the data loader and expected volume of data is known, bandwidth management can also be performed more efficiently.

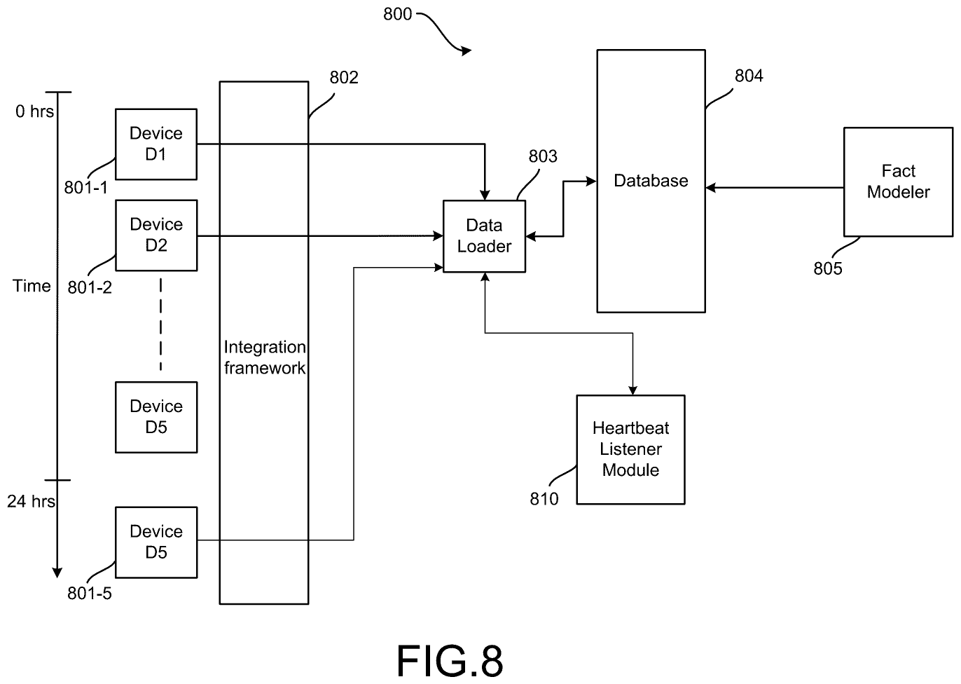

In another embodiment of the present invention, the proposed system may be used for updating of all the applicable fields/reports/tables in a database based on a trigger provided by a heartbeat listening module, as illustrated in FIG. 8. In prior art systems, all applicable fields/reports/tables in a database is updated by a fact modeler as per predefined schedules. For instance, the scheduled timing for updating the fields of the database may be 6 hours, and thereby, the fields are updated every 6 hours regardless of when past data from a device which had gone offline is loaded into tables of the database. This shortcoming of the existing systems is addressed by this embodiment of the present invention, wherein a trigger is sent by a heartbeat listener module 810 to a fact modeler 805. The trigger is sent by the heartbeat listener module 810 based on confirmation of completion of persisting of past data into the database. The confirmation of completion of persisting of past data into the database may be communicated to the heartbeat listener module 810 by a data loader 805. The trigger is sent by the heartbeat listener module 810 after data from devices is persisted by the data loader 803 into the database 804. Relevant fields of the database 804 are updated by the fact modeler 805 after receiving the trigger from the heartbeat listener module 810. Hence the trigger from the heartbeat listener module 810 acts as an indicator that persisting of data has been completed and updates by fact modeler 805 can be started. The updates made by the fact modeler 805 incorporates the changes made to the tables of the database 804 due to the loading of past data from different devices.

Embodiment of the present invention as per FIG. 8 may be used to prevent the delay in updating of error created in the database due to one or more devices going offline. Once the devices are back online, the past data is loaded onto the relevant tables of the database. However, a scheduled update cycle of the fields of the database would imply that the error values in the fields of the database will remain till it its next update as per the scheduled update cycle. Hence, a delay in updation of correct values is prevented by this embodiment of the present invention. In one instance, the trigger provided by the heartbeat listener module 810 may be a flag, a signal, or any other form of notification. The trigger-based update of the database 804 is independent of the schedule update cycle of the database 804 by the fact modeler 805. As per an embodiment of the present invention, even if the scheduled execution of the fact modeler 805 is at a later time, the system data will not remain inaccurate till such time, the heartbeat listener 810 will trigger an unscheduled execution of the fact modeler 805 and this ensures that system data is timely updated and is accurate.

Such unscheduled execution of fact modeler 805 may be a full execution, as would have happened at a scheduled execution or may be for a few fields only, as are impacted by the past data. Further, the unscheduled execution may even change the cycle of future scheduled executions of the fact modeler or future executions may remain unchanged. Present discourse is not limited by such modification and execution of fact modeler.

In an embodiment of the present disclosure, multiple devices 801 may experience downtime at any instance and may come back online at the same time (not shown in FIG. 8). When the devices 801 back online, they will start sending their past data to the data loader 803. In an embodiment, the data loader 803 will perform persisting of past data of these multiple devices 801. Once persisting of past data of one of the devices in completed, the data loader 803 sends a signal to the heartbeat listener 810. Based on the signal received, the heartbeat listener 810 may trigger a run of the fact modeler 805. Thereafter, once persisting of past data of the other device is completed, signal regarding the same is provided to the heartbeat listener 810. Based on this feedback the heartbeat listener 810 may trigger another run of the fact modeler 805. In an alternative embodiment, the heartbeat listener 810 may delay the trigger to the fact modeler 805. Particularly, instead of triggering fact modeler 805 upon completion of persisting of past data of the first device, the heartbeat listener 810 will trigger the run of the fact modeler 805 after complete of persisting of past data of all the multiple devices 801. This will avoid multiple run of the fact modeler 805 and hence, improve system efficiency. In a still alternative embodiment, the re-run of the fact modeler 805 may be triggered upon completion of persisting of only some of the multiple devices.

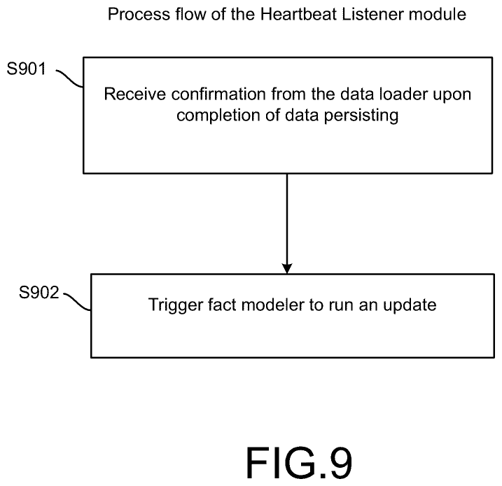

FIG. 9 illustrates an exemplary flow chart of the steps executed by the heartbeat listener module, in accordance with the embodiment of FIG. 8 of the present invention. The heartbeat listener module waits for a confirmation from the data loader of completion of data persisting to relevant tables of the database in step S901.

On receiving confirmation, the heartbeat listener module executes step S902 involving sending a trigger to the fact modeler for execution of an update. Particularly, the heartbeat listener module triggers execution of the fact modeler to update the system with correct and accurate data. Such execution of the fact modeler based on a trigger provided by the heartbeat listener module can be independent of scheduled executions of the fact modeler and this ensures that system gets updated with accurate data timely. Accordingly, even if the scheduled execution of the fact modeler is much later, the system data will not remain inaccurate till next scheduled execution of the fact modeler, rather based on the feedback received from the data loader, the heartbeat listener will trigger an unscheduled execution of the fact modeler and this ensures that system data is timely updated and is accurate. This unscheduled execution of fact modeler may be a full execution, as would have happened at a scheduled execution or may be for a few fields only, as are impacted by the past data. Further, the unscheduled execution may even change the cycle of future scheduled executions of the fact modeler or future executions may remain unchanged. Furthermore, the heartbeat listener module may even receive confirmation from the fact modeler regarding its successful run and hence, the heartbeat listener module is aware that the system data is UpToDate.

The present system may be used for effective management of past data obtained from different types of devices, based on the application of the system. The devices connected to the heartbeat listener module (via the IF) and the data loader may be any device used for generating or providing data, and may refer to, for example, one or more computers, sensors, industrial units, computing entities, desktop computers, mobile phones, tablets, phablets, notebooks, laptops, distributed systems, servers, or the like, and/or any combination of devices or entities adapted to perform the functions, operations, and/or processes described herein. In one embodiment, these functions, operations, and/or processes can be performed on data, content, information, and/or similar terms used herein. In various embodiments, the devices may also include a cloud-server based system for accessing data from a database hosted by a cloud server.

The data generated by the devices may be of different types and sizes based on the nature of application of the system and the operations performed by the devices. The heartbeat listener module may operate effectively in assisting the operations of the data loader and the fact modeler regardless of the properties of the data obtained from the devices. In some embodiments, in addition to data obtained from devices through the IF, data may be provided from an external source such as a cloud servers directly to the heartbeat listener module, and may be effectively persisted into the database using the data loader.

The figures of the disclosure are provided to illustrate some examples of the invention described. The figures are not to limit the scope of the depicted embodiments or the appended claims. Aspects of the disclosure are described herein with reference to the invention to example embodiments for illustration. It should be understood that specific details, relationships, and method are set forth to provide a full understanding of the example embodiments. One of ordinary skill in the art recognize the example embodiments can be practiced without one or more specific details and/or with other methods.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

The phrases “in one embodiment,” “according to one embodiment,” and/or the like generally mean that the particular feature, structure, or characteristic following the phrase may be included in at least one embodiment of the present disclosure and may be included in more than one embodiment of the present disclosure (importantly, such phrases do not necessarily refer to the same embodiment). The present disclosure intends to include specific reference to all combinations and sub combinations of physically compatible features, components, apparatuses, and processes described herein. As used herein, the term “or” is used in both the alternative and conjunctive sense, unless otherwise indicated. Use of any such aforementioned terms, or similarly interchangeable terms, should not be taken to limit the spirit and scope of embodiments of the present invention. As used in the specification and the appended claims. The singular form of “a,” “an,” and “the” include plural references unless otherwise stated. The terms “includes” and/or “including,” when used in the specification, specify the presence of stated features, elements, and/or components, and/or groups thereof. Also, phrases like ‘persisting of data’, ‘data persisting’, ‘persisted data’, ‘data persisted’ recite similar scope of processing done on the data by the data loader.

Aspects of the present disclosure may be implemented as computer program products that comprise articles of manufacture. Such computer program products may include one or more software components including, for example, applications, software objects, methods, data structure, and/or the like. In some embodiments, a software component may be stored on one or more non-transitory computer-readable media, which computer program product may comprise the computer-readable media with software component, comprising computer executable instructions, included thereon. The various control and operational systems described herein may incorporate one or more of such computer program products and/or software components for causing the various conveyors and components thereof to operate in accordance with the functionalities described herein.

A software component may be coded in any of a variety of programming languages. An illustrative programming language may be a lower-level programming language such as an assembly language associated with a particular hardware architecture and/or operating system platform/system. Other example of programming languages included, but are not limited to, a macro language, a shell or command language, a job control language, a script language, a database query, or search language, and/or report writing language. In one or more example embodiments, a software component comprising instructions in one of the foregoing examples of programming languages may be executed directly by an operating system or other software component without having to be first transformed into another form. A software component may be stored as a file or other data storage methods. Software components of a similar type or functionally related may be stored together such as, for example, in a particular directory, folder, or repository. Software components may be static (e.g., pre-established, or fixed) or dynamic (e.g., created or modified at the time of execution).

While this specification contains many specific implementation details, these should not be construed as limitations on the scope of any disclosures or of what may be claimed, but rather as descriptions of features specific to particular embodiments of particular disclosures. Certain features that are described herein in the context of separate embodiments can also be implemented in combination in a single embodiment. Conversely, various features that are described in the context of a single embodiment can also be implemented in multiple embodiments separately or in any suitable sub combination. Moreover, although features may be described above as acting in certain combinations and even initially claimed as such, one or more features from a claimed combination can in some cases be excised from the combination, and the claimed combination may be directed to a sub combination or variation of a sub combination.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

It is to be understood that the disclosure is not to be limited to the specific embodiments disclosed, and that modifications and other embodiments are intended to be included within the scope of the appended claims. Although specific terms are employed herein, they are used in a generic and descriptive sense only and not for purposes of limitation, unless described otherwise.

1. A system, comprising:
one or more devices configured to transmit data, the data comprising at least one of device status, downtime data, uptime data, metadata of the downtime data;
a heartbeat listener operatively connected to the one or more devices and configured to receive the device status;
a data loader operatively connected to the one or more devices and configured to persist the uptime data;
a fact modeler configured to process the uptime data persisted by the data loader; wherein, the heartbeat listener is further configured to:
determine from the device status, the downtime duration of one or more devices;
transmit the metadata of the downtime data associated with the downtime duration of the one or more devices to the data loader, wherein the data loader is further configured to receive and persist the downtime data from one or more devices; and
trigger the fact modeler to re-process the uptime and downtime data persisted by the data loader.

2. The system of claim 1, wherein the metadata comprises device down time span, device up time, amount of data, number of records, flow rate, number of time units the device was down.

3. The system of claim 1, wherein the heartbeat listener receives the device status continuously or at discrete internals.

4. The system of claim 1, wherein the metadata comprises time needed to persist the data.

5. The system of claim 1, wherein the heartbeat listener updates the metadata before transmitting to the data loader.

6. The system of claim 1, wherein the data loader is further configured to follow a different persisting logic for the downtime data.

7. The system of claim 1, wherein the trigger is made upon completion of the persisting of the downtime data by the data loader.

8. The system of claim 7, wherein the data loader system further configured to send feedback to the heartbeat listener, wherein the feedback comprises information relating to completion of the persisting of downtime data.

9. The system of claim 1, wherein the fact modeler if further configured to send a confirmation to the heartbeat listener, upon completion of the re-processing.

10. The system of claim 1, wherein the heartbeat listener is connected to the one or more devices via an Integration Framework.

11. A method comprising:
transmitting data, by one or more devices, the data comprising at least one of device status, downtime data, uptime data, metadata of the downtime data;
receiving, at a heartbeat listener, the device status;
persisting, by a data loader, the uptime data transmitted by the one or more devices,
processing, by a fact modeler, the uptime data persisted by the data loader;
determining from the device status, the downtime duration of one or more devices;
transmitting the metadata of the downtime data associated with the downtime duration of the one or more devices to the data loader, wherein the data loader is receiving and persisting the downtime data from one or more devices; and
triggering the fact modeler to re-process the uptime and downtime data persisted by the data loader.

12. The method of claim 11, further comprising computing time required for persisting of downtime data by the data loader.

13. The method of claim 11, further comprising receiving, by the heartbeat listener, a feedback from the data loader regarding the completion of persisting of downtime data.

14. The method of claim 13, wherein the triggering is performed based on the feedback from the data loader.

15. The method of claim 12, further comprising receiving, by the heartbeat listener, a confirmation from the fact modeler regarding the completion of re-processing.

16. The method of claim 11, wherein the metadata comprises device down time span, device up time, amount of data, number of records, flow rate, number of time units the device was down.

17. The method of claim 11, wherein the persisting of data by the data loader follows a different persisting logic for the downtime data.

18. The method of claim 11, wherein the heartbeat listener receives the device status continuously or at discrete internals.

19. The method of claim 11, wherein the heartbeat listener updates the metadata before transmitting to the data loader.

20. A non-transitory computer-readable storage medium comprising computer program code for execution by one or more processors of an apparatus, the computer program code configured to, when executed by the one or more processors, cause the apparatus to:
transmit data, by one or more devices, the data comprising at least one of device status, downtime data, uptime data, metadata of the downtime data;
receive, at a heartbeat listener, the device status;
persist, by a data loader, the uptime data transmitted by the one or more devices,
process, by a fact modeler, the uptime data persisted by the data loader;
determine from the device status, the downtime duration of one or more devices;
transmit the metadata of the downtime data associated with the downtime duration of the one or more devices to the data loader, wherein the data loader is configured to receive and persist the downtime data from one or more devices; and
trigger the fact modeler to re-process the uptime and downtime data persisted by the data loader.
